(19) United States
(12) Patent Application Publication
(10) Pub. No.: US 2007/0277425 A1
(43) Pub. Date: Dec. 6, 2007

(54) Snake trap with extensible structure

(76) Inventor: Michael Keith Beck, Seymour, TX (US)

Correspondence Address: Thomas E. Sisson;Jackson Walker, LLP, Suite 2400, 112 E. Pecan, San Antonio, TX, 78205, US

(21) Appl. No.: 11/803,190

(22) Filed: May 14, 2007

Related U.S. Application Data
(60) Provisional application No. 60/799,992, filed on May 12, 2006.

(51) Int. Cl. A01K 69/06

(52) U.S. Cl. 43/65

(57) ABSTRACT

An apparatus to capture snakes or small animals has an inner extensible coil spring support structure having shape memory. The support structure is overlaid or enclosed by a flexible mesh netting having open spaces whereby the snakes may pass through the spaces only when moving in a first forward direction. A deployment container houses the support structure and the netting when the support structure is in a retracted position. Multiple layers of concentrically arranged netting with different mesh sizes may be used to enclose the support structure.

This is an original patent application that claims priority to co-pending U.S. Provisional Patent Application Ser. No. 60/799,992, filed May 12, 2006, which provisional application is incorporated herein by reference for all purposes.

### BACKGROUND OF THE INVENTION

Snakes, particularly venomous such as rattlesnakes and copper heads, cause a health risk to people and animals. They frequent areas occupied by humans or domestic animals. There are various repellents and mechanical products currently available to capture these animals.

U.S. Pat. Nos. 4,370,823; 4,449,316; and 4,489,516 disclose a device for trapping snakes and similar animals having a sheet of netting to be placed on the ground shaped so that a plurality of areas of the netting are substantially non-horizontal to the ground. The device disclosed in the above identified patents is formed by folding the netting and heat-setting the desired shape. Once the shape is set, it may not be unfolded into its original configuration. The present invention discloses an apparatus that can be easily transported and deployed in areas where snakes are a problem.

When the present invention is required to be relocated, it is collapsible or contractible to its original configuration, easily placeable into its storage receptacle, and becomes immediately re-deployable at a new location. Typical uses for the invention would be in areas where farm workers are working, for campers, schools, for the military, chicken farms, and other areas where people or animals need to be protected.

### SUMMARY OF THE INVENTION

The present invention uses a netting material, such as that used to repel birds from fruit trees, covering an extensible, coil spring support structure to trap snakes as they crawl on the ground or in trees. The snakes crawl into the open spaces in the netting between the interstices of the netting strands and become ensnared because the snake cannot slide out of the space in the reverse direction.

The present invention also discloses a method of assembly that makes the device easy to deploy. One embodiment of the invention uses a coil spring configuration constructed of metal or plastic wire or some other material having a shape memory to form the support for the netting material. The netting material may be formed in the shape of a cylindrical tube or conduit or may be draped as sheets over the support structure and attached with clips. Sufficient netting material is used so the area around the support is covered by the netting material when the structure is extended or expanded.

The support structure and netting material may be collapsed or contracted to a small size and installed into a box, container, or other appropriate storage/deployment receptacle. When the end of the container is opened, the trap device having the netting covering the coiled, collapsed support structure may be easily pulled out and deployed in selected areas. Just as quickly, the extended coil with the net covering may be compressed, contracted, or collapsed to its original form and returned to the container.

The user may simply install the trap where snakes frequent and secure the trap to the ground with weights, stakes or some other securing device. In many cases, no securing mechanism is needed, because the weight of the support structure is sufficient to keep the device in place.

The enclosed drawings show the trap being deployed on the ground, but the device may also be hung from trees or other structures where snakes frequent.

Snake bait may also be used with the trap. The bait may be physically placed inside the trap device or the bait aroma may be incorporated into the plastic netting itself.

### BRIEF DESCRIPTION OF THE DRAWINGS

FIG. 1 illustrates a perspective view of the device prior to deployment with the netting in the form of a tube with the coil support structure positioned inside the netting.

FIG. 2A is a top plan view of the present invention inside a storage/deployment container.

FIG. 2B is a side elevation view of the present invention in a storage container.

FIG. 3 is a perspective view of the present invention in its extended, deployed position with a cylindrical netting tube covering the support structure.

FIG. 4 illustrates a perspective view of the trap being deployed out of its storage container.

FIG. 5 is a side elevation cross-section view of an embodiment of the present invention having three separate netting layers, each layer having a different mesh size.

### DESCRIPTION OF THE PREFERRED EMBODIMENT

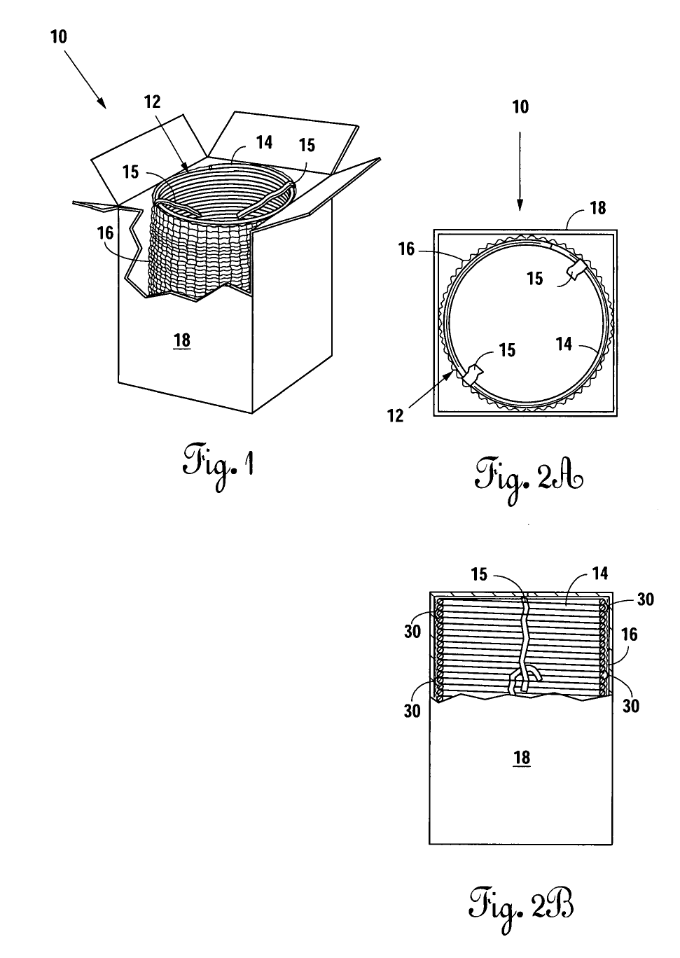

As shown in FIG. 1, an embodiment of present invention 10 includes a trap mechanism 12 having a coil spring support structure 14 and a covering of netting 16 contained in a retracted, contracted or compressed position within a storage or deployment container 18. It should be understood that the netting is formed by a plurality of strands 20 joined together at interstices to create openings 32 in the net. The embodiment of FIG. 1 has a single layer of netting 16, but other embodiments may include several separate netting layers with each layer having different sized openings.

As will be described further, this layering allows for one unit to trap a wider range of snake sizes. Each end of the support structure 14 is provided with a tape, rope or other tab member 15 which facilitates withdrawing the spring from the box and which may be used to tie the spring down when the spring is extended in use.

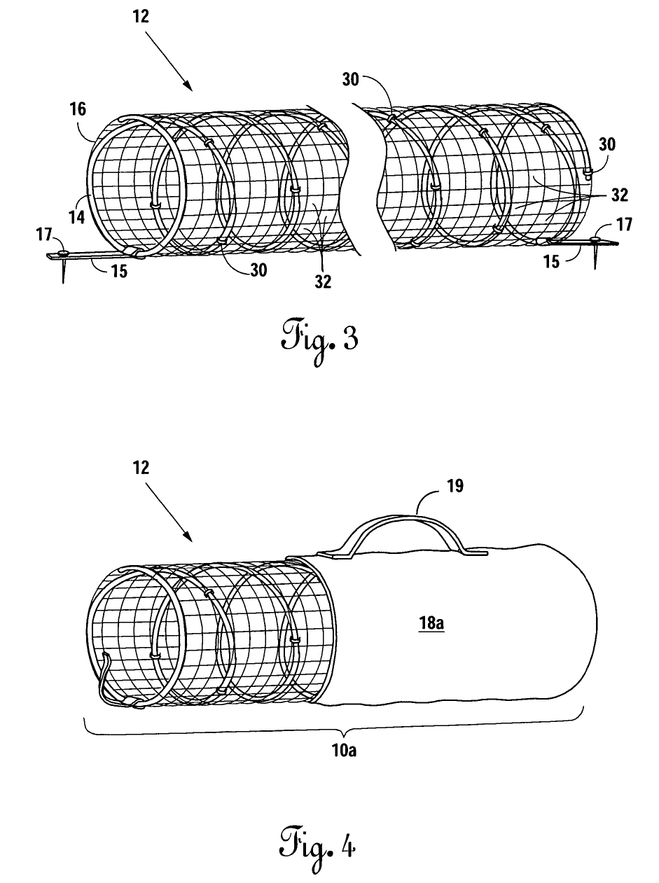

FIG. 2A illustrates a top plan view of the present invention 10 with the trap mechanism 12 within the container 18. The netting 16 encloses the coil spring support structure 14. In some embodiments, the netting may be a cylindrical, mesh-tube, sheath or sleeve which has an inside diameter larger than the outside diameter of the coil spring. The netting tube 16 may be attached to the spring 14 by suitable clips 30 (see FIGS. 2B and 3). In some embodiments, the netting is a sheet (or sheets) of mesh material which is simply wrapped around the spring like the outer tobacco wrapper of a cigar. Clips may be used to retain the outer netting to the coil spring.

The coil spring support structure 14 may vary in size according to particular trapping applications. A 0.072″ gauge×7″ O.D. (outside diameter) 304 stainless wire has been used in some applications. The wire has a structural memory which allows it to generally return to its original coiled length after it has been extended. Three inches of collapsed wire may stretch or expand to approximately thirty feet and lose only 10%-15% of its outside diameter. Other structures have utilized 0.062″×5″ O.D. 302 stainless wire. It is anticipated that plastic coil spring materials (such as a styrene-butadiene copolymer) may be used with some decrease in retraction or collapse memory when exposed to harsh temperature and humidity conditions in application.

In all embodiments, it is the extensible quality of the support structure 14 which allows the trapping mechanism 12 to be easily stored, deployed, retracted, and restored without entanglement of the mesh netting 16. The tab or rope 15 is used to pull the mechanism 12 from the storage container. When the mechanism is compressed for relocation, the tab may be used to wrap around the retracted spring making it easy to insert the mechanism into the storage container. Typically, netting is made of a polyethylene material or plastic covered thread and is flexible so as to generally loosely conform to the cylindrical shape of the coil structure (whether extended or collapsed).

FIG. 3 illustrates the trapping mechanism 12 in an extended, deployed position. The coil structure 14 has been deployed from the container 18. Tapes 15 have been attached to the ground by stakes 17. The netting 16 is shown wrapped about the support structure 14 and attached to the spring by clips 30. The open spaces 32 in the netting are exposed so that snakes may slide into the spaces only when moving in a forward direction and not be able to slide back out of the spaces when moving in a reverse direction. From FIG. 3, it should be understood that stakes 17 could be inserted through clips 30 to further secure the trap to the ground. When the trap is affixed to a tree limb or building structure, tapes 15 or clips 30 may be utilized.

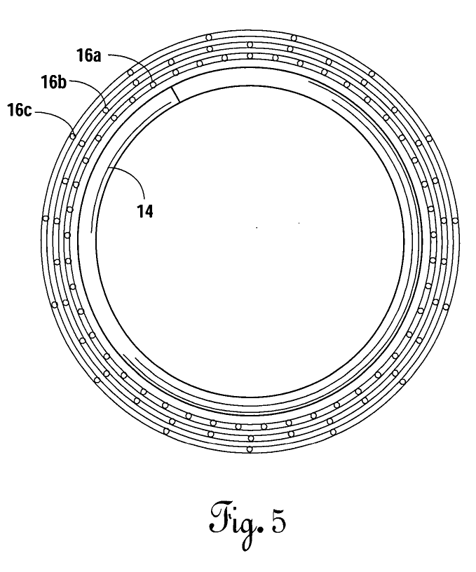

FIG. 4 is an illustration of yet another embodiment 10a wherein the trapping mechanism 12a is being deployed from a canvas bag container 18a having a carrying strap 19.

It has been found that where several, separate layers of different sized mesh netting is used to cover the support structures, increased capture rates may be achieved. FIG. 5 is a cross-section illustration of the mechanism 12 with a coil spring 14 having three separate concentrically overlaying layers of different sized mesh netting 16a, 16b, and 16c. The inner layer 16a has the smallest mesh, the middle layer 16b has the next larger mesh, and the outer layer 16c has the largest mesh. For example, inner layer 16a may be a 0.50″×0.50″ mesh. Middle layer 16b may be 0.75″×0.75″ mesh. Outer layer 16c may be 1.25″×1.25″ mesh.

The snakes with the smallest body outside diameter will become entangled in the inner layer, while snakes having a body diameter of about 1″ will be entangled between the inner layer 16a and the middle layer 16b. Some larger snakes will be able to pass through the outer layer 16c, only to become entangled between the middle layer 16b and the outer layer 16c.

In all of the embodiments, the support structure 14 allows the netting 16 to be easily expanded or retracted and stored in the deployment container 18. The support structure 14 maintains the netting in a generally cylindrical shape when deployed which allows snakes to slide into the open spaces 32 of the netting mesh. When separate layers of netting 16a-16c cover the support structure, the support structure allows the netting layers to remain in a generally concentric arrangement when being deployed or being compressed for storage.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that the appended claims will cover such modifications that fall within the true scope of the invention.

1. An apparatus to capture snakes or small animals comprising:
an extensible support structure adapted to move from a first retracted position to a second deployable position; and
a flexible mesh netting overlaying said support structure, said mesh having open spaces whereby said snakes or small animals may pass through said spaces only when moving in a first direction.

2. The apparatus of claim 1 further comprising a deployment container adapted to store said support structure and said netting when in said first retracted position.

3. The apparatus of claim 1 wherein said flexible mesh netting comprises a plurality of overlaying, generally concentric layers of netting material.

4. The apparatus of claim 3 wherein said plurality of overlaying, generally concentric layers of netting material comprises a first inner layer having a first mesh size and a second outer layer having a second larger mesh size.

5. The apparatus of claim 4 further comprising a third middle layer, said middle layer having a mesh size greater than said first inner layer and a mesh size less than said second outer layer.

6. The apparatus of claim 1 wherein said extensible support structure comprises a coil spring member having a shape memory.

7. The apparatus of claim 6 further comprising deployment members attached to first and second opposite ends of said coil spring member.

8. The apparatus of claim 1 further comprising clips securing said flexible mesh netting to said support structure.

9. The apparatus of claim 1 wherein said flexible mesh netting is a generally cylindrical tube sheath adapted to enclose said support structure.
